(19) United States
(12) Patent Application Publication
(10) Pub. No.: US 2017/0155264 A1
(43) Pub. Date: Jun. 1, 2017

(54) PADFOLIO WITH RECHARGEABLE BATTERY

(71) Applicant: Todd Owen, Litchfield Park, AZ (US)

(72) Inventor: Todd Owen, Litchfield Park, AZ (US)

(21) Appl. No.: 14/956,281

(22) Filed: Dec. 1, 2015

(51) Int. Cl. H02J 7/00; B42F 7/06; A45C 13/02; A45C 11/34; A45C 13/10

(52) U.S. Cl. CPC H02J 7/0045; A45C 11/34; A45C 13/103; A45C 13/02; B42F 7/06

(57) ABSTRACT

The present invention relates to a padfolio including a case and a zipper or a clasp that couples a first portion and a second portion of the case, the first portion and the second portion connected via a binding. The padfolio can be folded open to expose an interior. The interior contains a notepad and various sleeves, pockets and compartments useful for storing items such as writing instruments, business cards, paper clips, a calculator, etc. A battery is concealed within the interior, wherein access to the battery is from an access opening that includes a plurality of USB ports. Preferably, the battery will be a rechargeable lithium-ion battery. The battery can be used to charge a mobile device such that the user does not have to rely on there being an electrical outlet nearby for charging purposes.

### BACKGROUND OF THE INVENTION

1. Field of the Invention

The present invention relates to a padfolio equipped with an integrated rechargeable battery.

2. Description of the Related Art

A padfolio is a portable case that opens in the manner of a book to reveal a paper notepad. Padfolios typically come in letter-size or legal pad size, which refers to the size of the notepad and the approximate size of the padfolio when closed. Some padfolios have zippers while others have buckle-type closures instead. Padfolios are very convenient for executives and other users to take and organize notes.

Padfolios may include various sleeves, pockets and compartments useful for storing items such as writing instruments and even small office equipment. For example, U.S. Pat. No. 7,281,877 to Lederer et al. discloses a zippered padfolio having a notepad, a clock, a calculator, and a personal digital assistant (PDA). Other padfolios can be fitted with a tablet computer, such as an Apple iPad. This arrangement is useful for those who want to take handwritten notes along with having access to a computing device. Alternatively, many people will simply bring a tablet or smartphone along with a padfolio to a meeting.

### SUMMARY OF THE INVENTION

The present invention relates to a padfolio including a case and a zipper or a clasp that couples a first portion and a second portion of the case. The padfolio can be folded open to expose an interior. The interior contains a notepad and various sleeves, pockets and compartments useful for storing items such as writing instruments, business cards, paper clips, a calculator, etc. A battery is concealed within the interior, wherein access to the battery is from an access opening that includes a plurality of USB ports. Preferably, the battery will be a rechargeable lithium-ion battery. The battery can be used to charge a mobile device such that the user does not have to rely on there being an electrical outlet nearby for charging purposes.

### BRIEF DESCRIPTION OF THE DRAWINGS

FIG. 1 illustrates an exemplary padfolio, according to a first embodiment;

FIG. 2 illustrates the padfolio of FIG. 1 in an open position;

FIG. 3 illustrates a side view of the padfolio of FIG. 1;

FIG. 4 illustrates an exemplary padfolio, according to a second embodiment;

FIG. 5 illustrates a side view of the padfolio of FIG. 4;

FIG. 6 illustrates a battery housing useable in conjunction with the padfolio of FIG. 4; and

FIG. 7 illustrates the padfolio of FIG. 4 in an open position.

### DETAILED DESCRIPTION OF THE INVENTION

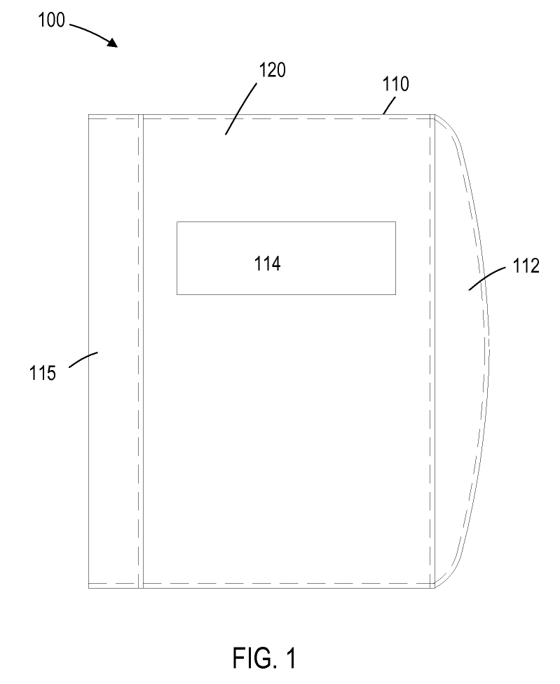

FIG. 1 illustrates a front view of an exemplary padfolio 100, in a closed position, according to a first embodiment. The padfolio 100 includes a case 120 having a perimeter 110 and a binding 115. As will be described in greater detail, the padfolio 100 can be closed (and opened) using a zipper that runs around the length of the perimeter 110 except for at the binding 115. The case 120 will preferably be constructed of a durable, soft material, such as leather or vinyl. The case 120 will be slightly larger than the dimensions of a notepad stored in the padfolio 110. As illustrated, the case 120 includes an optional exterior side pocket 112 that may be used to store objects such as papers that may be conveniently accessed from outside of the padfolio 100. The case 120 may include functional indicia 114 disposed on a front of the case 120. The functional indicia 114 can include a logo to identify the padfolio 100 and to prevent it from being lost or mixed-up with other padfolios 100, for example. Alternatively, the functional indicia 114 may be printed on the padfolio 100 for promotional purposes. In general, the functional indicia 114 can include any text or symbol having meaning, or there may be no functional indicia 114 on the case 120.

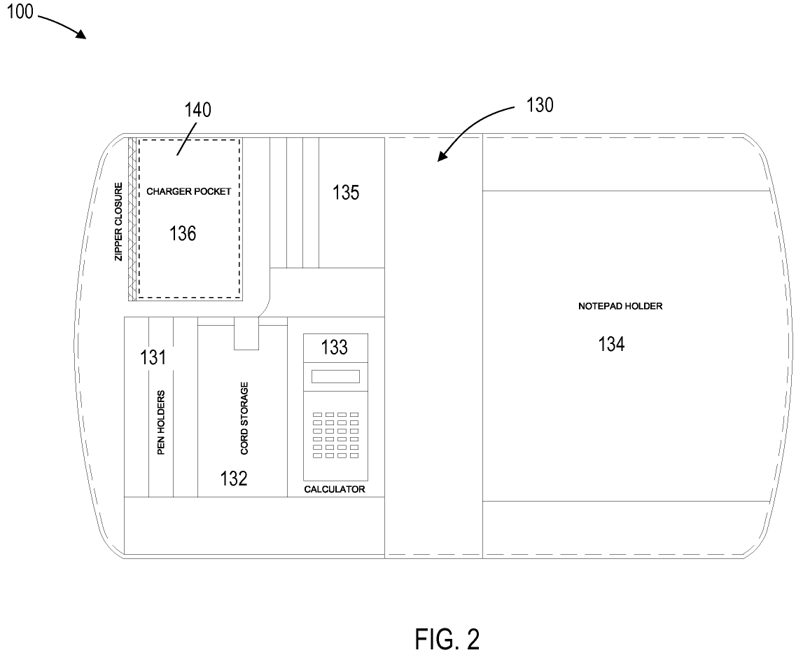

FIG. 2 illustrates the padfolio 100 in an open position. The padfolio 100 can be unzipped to expose an interior 130 of the padfolio 100. The interior 130 includes one or more pen holders 131, an electric cord storage compartment 132, a calculator 133, a notepad holder 134, one or more pockets 135 and a charger pocket 136. The one or more pen holders 131 may each accommodate a pen, a pencil or other writing instrument (not shown). Depending on user requirements, the notepad holder 134 can hold a notepad of letter-size (8.5×11 inches), legal-size (8.5×14 inches) or A4 size (8.27 in×11 for example. The electric cord storage compartment 132 may contain an electric charging cord. The electric cord storage compartment 132 can be closed by a hook and loop fastening tab or another fastener to conveniently store the electric cord. The calculator 133 can be secured against the interior 130 of the padfolio 100 and be conveniently accessed to perform one or more mathematical calculations. The notepad holder 134 can be secured against the interior 130 of the padfolio 100, and be conveniently accessed to write notes and the like on. The pockets 135 can each be one of a plurality of slots to receive an object such as a business card or the like. While the interior 130 of the padfolio 100 is shown with various items, sleeves, pockets, and compartments, it is to be understood that the interior 130 is shown for illustrative purposes only and that another structure and arrangement may suffice.

Notably, and importantly, the charger pocket 136 will contain a battery 140. The charger pocket 136 can be constructed of cloth material sewn under a liner, or a suitable plastic molded piece, sized in conformity with the dimensions of the battery 140. In an embodiment, the charger pocket is approximately 5 inches high and 3.5 inches in width. The battery 140 can be a lithium-ion rechargeable battery or other type of suitable rechargeable battery or the like. As will be described in greater detail, the battery 140 can be used to charge a mobile device such that the user does not have to rely on there being an electrical outlet nearby or a desktop computer available for charging purposes.

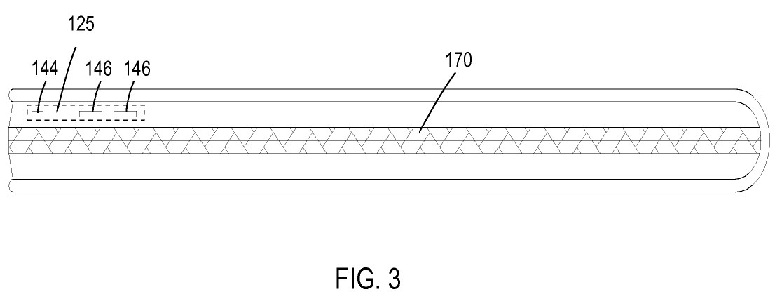

FIG. 3 illustrates a side view of the padfolio 100. As shown, an access opening 125 adjacent a zipper 170 exposes a micro USB port 144 and two serial bus or USB ports 146. The charging micro USB port 144 may utilize a suitable charging cord connected to an adapter (such as a wall adapter) to charge the battery 140. The charging cord can be stored in the electric cord storage compartment 132. The USB ports 146 may utilize a suitable cord to charge a mobile device wherein one end of the cord is USB-compatible. The one or more USB ports 146 may be a USB port 2.0, a USB port 3.0 or the like.

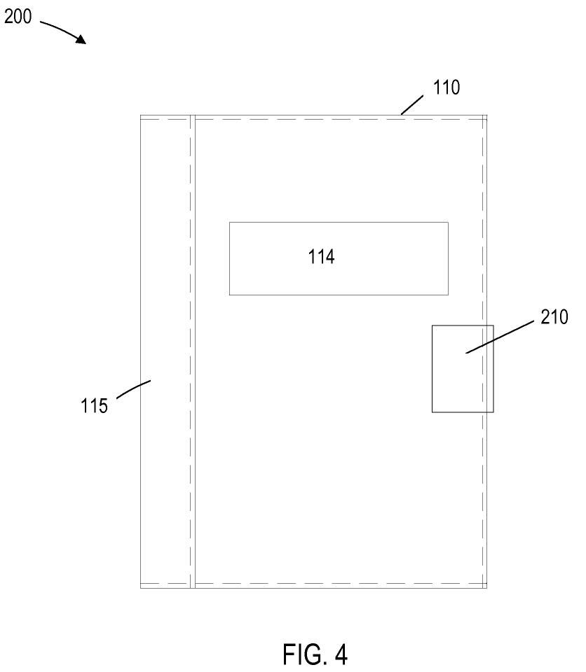

FIG. 4 illustrates an exemplary padfolio 200, according to a second embodiment. The padfolio 200 is substantially the same as the padfolio 100 except that the padfolio 200 is opened/closed using a clasp 210 rather than the zipper 170, and because there is no zipper 170, placement of the battery 140 is somewhat different.

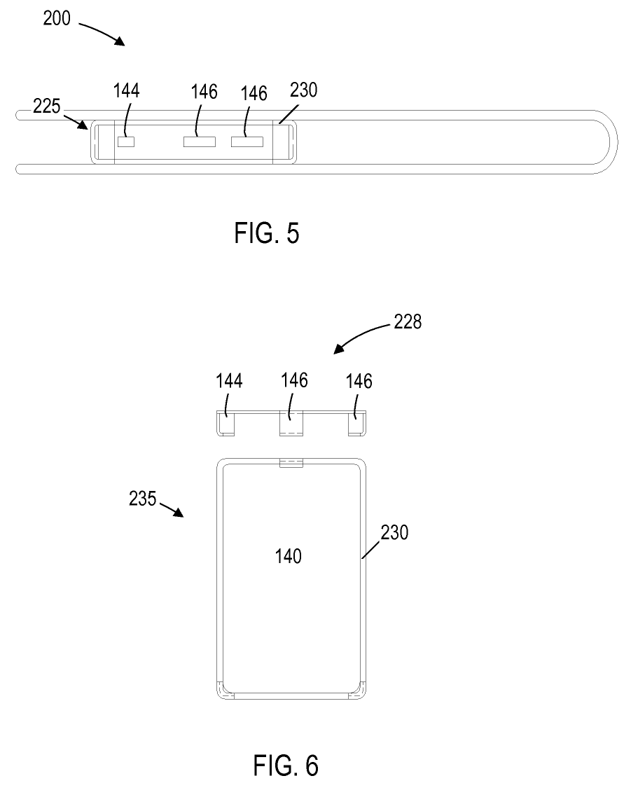

FIG. 5 illustrates a side view of the padfolio 200. As can be seen, an access opening exposes a micro USB port 144 and two serial bus or USB ports 146. A battery housing 235 houses the battery 140 and the USB ports 144, 146. FIG. 6 illustrates the battery housing 235 in greater detail. As shown, the battery housing 235 includes a case 230 that encapsulates the battery and can include an interface structure 228 that includes the micro USB port 144 and two serial bus or USB ports 146. The interface structure 228 can be attached to the battery holder 235 and is electrically connected to the battery 140.

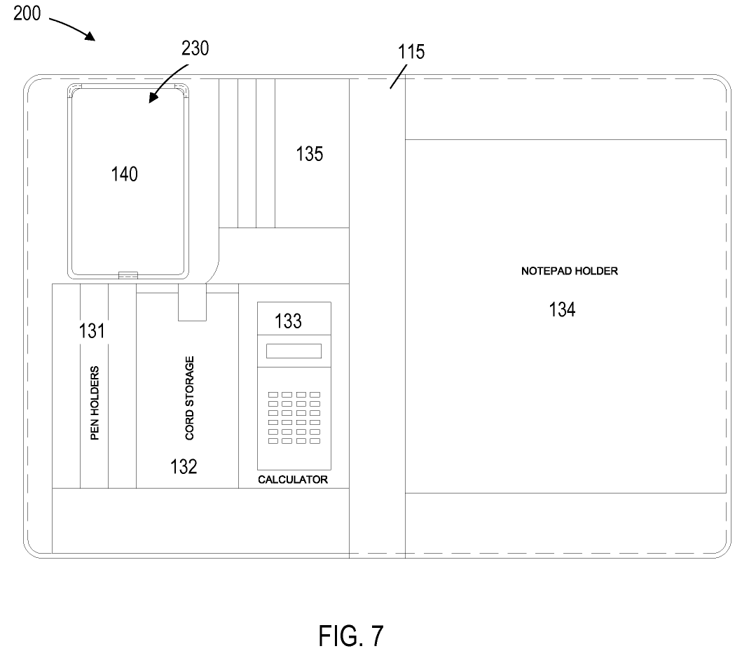

FIG. 7 illustrates the padfolio 200 in an open position. It is to be understood that the battery housing 235 and battery 140 can be hidden from view (e.g., disposed under a lining 230).

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A padfolio, comprising:
a case;
a coupling device that couples a first portion and a second portion of the case, the first portion and the second portion connected via a binding, wherein an interior of the padfolio is capable of being exposed when the coupling device is uncoupled; and
a battery concealed within the interior, wherein access to the battery is from an access opening, the access opening including at least one USB port for charging a mobile device and a micro-USB port for charging the battery.

2. The padfolio according to claim 1, wherein the interior of the padfolio includes an electric cord storage compartment with an electric cord stored therein.

3. A padfolio, comprising:
a case;
a zipper disposed around a perimeter of the case except at a binding, the zipper capable of being unzipped to expose an interior of the padfolio; and
a battery concealed within the interior of the portfolio, wherein access to the battery is from an access opening.

4. The padfolio according to claim 3, wherein the interior of the padfolio includes a charger pocket containing the battery, the charger pocket concealed from view when the interior is exposed.

5. The padfolio according to claim 3, wherein the access opening is situated adjacent the zipper.

6. The padfolio according to claim 3, wherein the battery is a lithium-ion rechargeable battery.

7. The padfolio according to claim 3, wherein the access opening includes charging ports.

8. The padfolio according to claim 7, wherein the charging ports include a USB port for charging a device connected to the battery and a micro-USB port for charging the battery.

9. The padfolio according to claim 3, wherein the case includes functional indicia.

10. The padfolio according to claim 3, wherein the case further includes an external pocket.

11. The padfolio according to claim 3, wherein the interior of the padfolio incudes at least one notepad holder.

12. The padfolio according to claim 3, wherein the interior of the padfolio includes an electric cord storage compartment with an electric cord stored therein.

13. A padfolio, comprising:
a case;
a clasp coupling a first portion and a second portion of the padfolio, the first portion and the second portion connected to a binding, wherein an interior of the padfolio is exposed when the clasp is released; and
a battery concealed within the interior of the portfolio, wherein access to the battery is from an access opening.

14. The padfolio according to claim 13, wherein the interior of the padfolio includes a charger pocket containing the battery, the charger pocket concealed from view when the interior is exposed.

15. The padfolio according to claim 13, wherein the battery is a lithium-ion rechargeable battery.

16. The padfolio according to claim 13, wherein the access opening includes charging ports.

17. The padfolio according to claim 16, wherein the charging ports include a USB port for charging a device connected to the battery and a micro-USB port for charging the battery.

18. The padfolio according to claim 13, wherein the case includes functional indicia.

19. The padfolio according to claim 13, wherein the interior of the padfolio incudes at least one notepad holder.

20. The padfolio according to claim 13, wherein the interior of the padfolio includes an electric cord storage compartment with an electric cord stored therein.
